(19) United States
(12) Patent Application Publication
(10) Pub. No.: US 2006/0290670 A1
(43) Pub. Date: Dec. 28, 2006

(54) Joy stick

(76) Inventor: Hiroshi Ishimaru, Tokyo (JP)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 11/412,873

(22) Filed: Apr. 28, 2006

(30) Foreign Application Priority Data
Jun. 27, 2005 (JP) P2005-186889

(51) Int. Cl. G09G 5/08

(52) U.S. Cl. 345/161

(57) ABSTRACT

A board has a first face and a second face opposite to the first face. A movable member is provided on the first face so as to be movable in a first direction. An operating stick is coupled to the movable member, thereby being movable in the first direction from a neutral position thereof. A first magnetic member is provided on the operating stick so as to oppose the first face. A second magnetic member is fixed on the second face so as to oppose the neutral position. The first magnetic member and the second magnetic member are configured to be attractive to each other.

### BACKGROUND OF THE INVENTION

The present invention relates to a joy stick.

As shown in FIGS. 10 and 11, a related-art joy stick for use in a game machine or the like comprises a casing 1; a board 2 covered by the casing 1; cranks 3 and a crank 4 disposed on the board 2 so as to be movable in an X direction and a Y direction, respectively; and an operating stick 5 provided on the casing 1. The operating stick 5 comprises a shaft 6, a circular flange 7 provided on an intermediate portion of the shaft 6, and a knob 8 provided on an upper end portion of the shaft 6. A lower end portion of the shaft 6 is engaged in central portions of the cranks 3 and 4. Springs 9 and 10 are respectively interposed between the respective one of the cranks 3 and 4 and the board 2.

According to the above-described configuration, as shown in FIG. 12, by a moving operation of the operating stick 5, the cranks 3 and 4 are moved in an X direction and a Y direction respectively, against forces of the springs 9 and 10. Their amounts of movement and moving directions are outputted as electrical signals by a detector (not shown). Then, if the operating force is released after the moving operation, the cranks 3 and 4 are moved to a position where the cranks 3 and 4 are located before the moving operation by the forces of the springs 9 and 10. Namely, the operating stick 5 is mechanically returned to a position of an origin of XY directions, i.e., to a neutral position by the springs 9 and 10. In a case where the operating stick 5 is moved in a diagonal direction to the X direction or the Y direction, the above-described returning action is effected. Meanwhile, this returning mechanism using springs is disclosed in, for example, Japanese Patent Publication No. 2001-266715A.

According to the related-art joy stick, when the operating stick 5 is moved in a diagonal direction with respect to the X direction or the Y direction, since the forces of the two springs 9 and 10 are applied, it is difficult to obtain a stable stick operation feeling. Further, since an expansion and a contraction of the spring in conjunction with the movement of the cranks 3 and 4, mechanical noise peculiar to spring is generated, causing a decline in quietness during the moving operation of the operating stick 5.

### SUMMARY OF THE INVENTION

It is therefore an object of the invention to provide a joy stick having a structure in which a stable stick operation feeling is obtained, and an improvement in quietness is attained.

In order to attain the above described object, according to the invention, there is provided a joy stick comprising:

a board, having a first face and a second face opposite to the first face;

a movable member, provided on the first face so as to be movable in a first direction;

an operating stick, coupled to the movable member, thereby being movable in the first direction from a neutral position thereof;

a first magnetic member, provided on the operating stick so as to oppose the first face; and

a second magnetic member, fixed on the second face so as to oppose the neutral position, wherein the first magnetic member and the second magnetic member are configured to be attractive to each other.

With this configuration, since the operating stick is returned to the neutral position by the magnetic force between the first member and the second member, even if the operating stick is moved in a diagonal direction with respect to the first and second directions, a stable operation feeling is obtained, and the operational stability improves. In addition, since mechanical noise accompanying the expansion and the contraction of the springs as in the related-art joy stick is not generated when the operating stick is moved, the quietness during the operation improves remarkably.

The first magnetic member may comprise a permanent magnet and the second magnetic member may comprise a permanent magnet.

With this configuration, a construction of the joy stick becomes simple, and the second member is fixed easily to the lower face of the board and located accurately on the position corresponding to the neutral position of the operating stick.

The first magnetic member may comprise a permanent magnet and the second magnetic member may comprise an electromagnet.

With this configuration, since the magnitude of the magnetic force of the second member may be varied freely in a wide range, it is possible to freely impart appropriate relative hardness to the stick operation feeling depending on the application and conditions of use of the joy stick.

The first magnetic member may comprise a permanent magnet and the second magnetic member may comprise a magnetic material.

With this configuration, the second member may be mounted easily and speedily, the construction may become simple and a lower cost may be attained.

The first magnetic member may comprise an electromagnet and the second magnetic member may comprise a permanent magnet.

The first magnetic member may comprise an electromagnet and the second magnetic member may comprise an electromagnet.

The first magnetic member may comprise an electromagnet and the second magnetic member may comprise a magnetic material.

With this configuration, since the magnitude of the magnetic force of the first member may be varied in a wide range, it is possible to eliminate the magnetic action by deactivating a power source of the electromagnet when the apparatus is not used. Therefore, even if the casing of the shaft does not have, for example, a hermetic structure, it is possible to reliably prevent the shaft from the attachment of foreign objects such as iron powder to the shaft.

The first magnetic member may comprise a magnetic material and the second magnetic member may comprise a permanent magnet.

The first magnetic member may comprise a magnetic material and the second magnetic member may comprise an electromagnet.

### BRIEF DESCRIPTION OF THE DRAWINGS

The above objects and advantages of the present invention will become more apparent by describing in detail preferred exemplary embodiment thereof with reference to the accompanying drawings, wherein:

FIG. 1 is an exploded perspective view of a joy stick according to a first embodiment of the invention;

FIG. 2 is a perspective view of an upper face side of a board incorporated in the joy stick shown in FIG. 1;

FIG. 3 is a perspective view of a lower face of the board of the joy stick shown in FIG. 1;

FIG. 4 is a front view of permanent magnets incorporated in the joy stick shown in FIG. 1;

FIG. 5 is a cross-sectional view of a joy stick according to a second embodiment of the invention;

FIG. 6 is a front view, partly in section, showing an operating stick returning to a neutral position in the joy stick shown in FIG. 5;

FIG. 7 is an exploded perspective view of a joy stick according to a third embodiment of the invention;

FIG. 8 is a perspective view of an upper face of a board incorporated in the joy stick shown in FIG. 7;

FIG. 9 is a front view, partly in section, of an electromagnets incorporated in the joy stick shown in FIG. 7;

FIG. 10 is a perspective view of a related-art joy stick;

FIG. 11 is a perspective view of an upper face of a board of the related-art joy stick shown in FIG. 10; and

FIG. 12 is a perspective view for explaining a returning action of an operating stick of the joy stick shown in FIG. 10.

### DETAILED DESCRIPTION OF THE EMBODIMENTS

Embodiments of the invention will be discussed in detail with reference to the accompanying drawings.

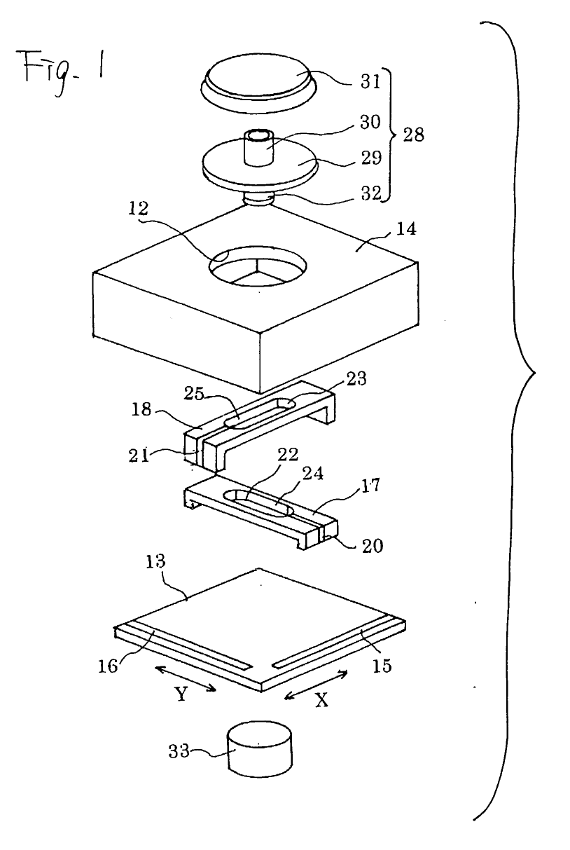

As shown in FIG. 1, according to a first embodiment of the invention, a box-shaped cover case 14 formed with a central hole 12 is mounted and fixed on a board 13. A lower side of the cover case 14 is open. Further, belt-shaped first contact portions 15 and 16 comprised of copper are respectively provided on adjacent side edges in an upper face of the board 13, and the contact portions 15 and 16 respectively extend in X and Y directions which are perpendicular to each other.

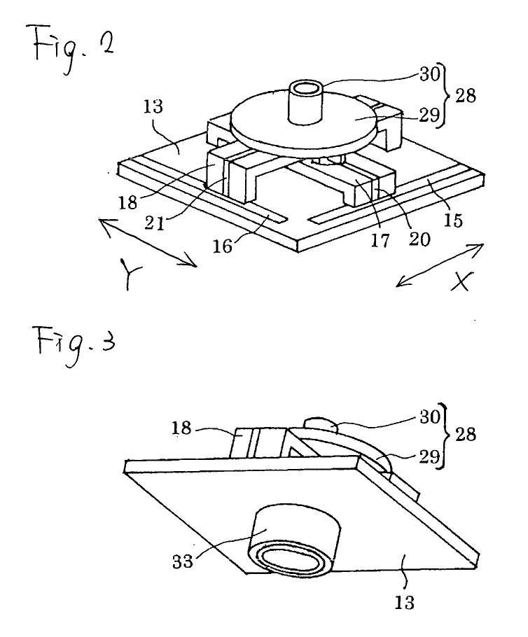

As shown in FIG. 2, a crank 17 having a U-shaped cross section is disposed on the board 13, and a crank 18 having a U-shaped cross section is mounted on the crank 17. The crank 17 is extended in the Y direction so as to be movable in the X direction. The crank 18 is extended in the X direction so as to be movable in the Y direction. The cranks 17 and 18 are guided in the X direction and the Y direction respectively by inner faces of the cover case 14.

As shown in FIG. 1, conductors 20 and 21 are respectively wired on obverse faces of the cranks 17 and 18. Slots 22 and 23 extending in the X direction and Y direction respectively are formed in central portions of the cranks 17 and 18. Second contact portions 24 and 25 comprised of copper are respectively formed on inner faces of the slots 22 and 23, and the second contact portions 24 and 25 are respectively connected to the first contact portions 15 and 16 through the conductors 20 and 21.

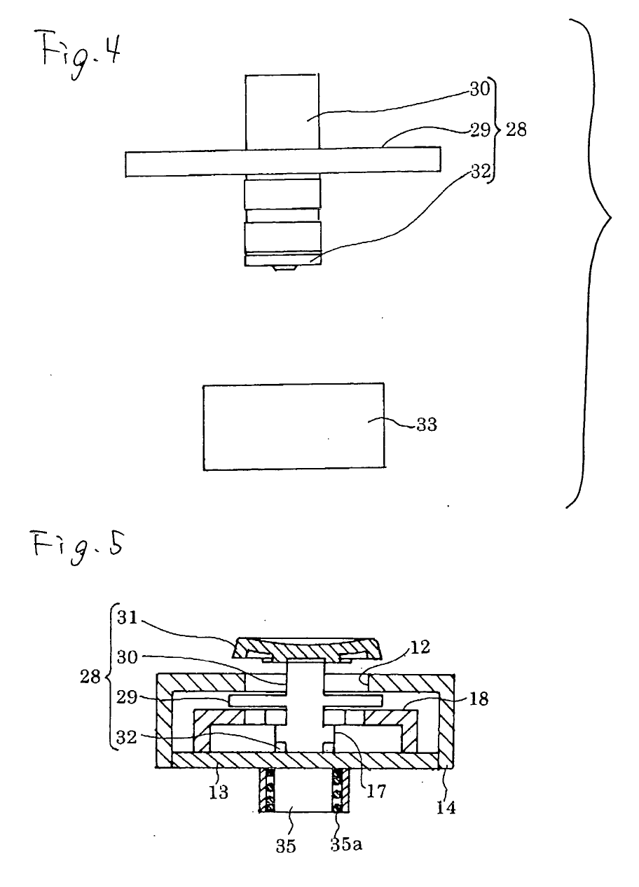

An operating stick 28 is operated so as to be moved in an arbitrary direction on X-Y coordinates. The operating stick 28 comprises a hollow shaft 30 having a circular flange 29 in an intermediate portion thereof, and a knob 31 attached to an upper end portion thereof. As shown in FIG. 4, a permanent magnet 32 is provided on a lower end portion of the shaft 30 integrally by an embedding method. The permanent magnet 32 is arranged so that attracting action by the N pole and the S pole is generated with respect to a permanent magnet 33 on the lower face of the board, which will be described below.

The upper end portion of the shaft 30 is loosely engaged to the central hole 12 of the cover case 14, and the knob 31 projects to an upper side of the central hole 12 so as to be freely moved by a moving operation of the operating stick 28. Further, the lower end portion of the shaft 30 is movable in an arbitrary direction from a neutral position while abutting against the contact portions 24 and 25. As shown in FIG. 3, the cylindrical permanent magnet 33 is fixed to the lower face of the board 13 at a position corresponding to the neutral position.

When an operating force is applied to the operating stick 28 so as to move the shaft 30 of the operating stick 28 in an arbitrary direction from the neutral position, the moving direction and the amount of movement of the shaft 30 are outputted as electrical signals by a detector (not shown). Then, since the attracting action by the N pole and the S pole is being constantly generated, when the operating force of the operating stick 28 is released, the shaft 30 is attracted by the permanent magnet 33 and is moved to a position above the permanent magnet 33. As a result, the operating stick 28 automatically is returned immediately to the neutral position where the operating stick 28 is located before the moving operation.

Thus, the operating stick 28, after the moving operation in the arbitrary direction, is returned to the neutral position accurately and smoothly by the magnetically attracting force. In particular, even in a case where the operating stick 28 is moved in a diagonal direction with respect to the X direction or the Y direction, since the forces of two springs are not applied to the operating stick 28 differently from the related-art joy stick, mechanical noise is eliminated, so that the operating noise of the operating stick 28 is made very quiet. In addition, since the operating stick 28 is returned in the neutral position in a non-contact manner, even if the operating stick 28 is moved in any direction, a stable operation feeling is constantly obtained, and the operating stability of the operating stick 28 improves appreciably, thereby making it possible to perform soft and speedy input operation.

Meanwhile, the lower end portion of the shaft 30 is not limited to a permanent magnet (including a rubber magnet) insofar as the lower end portion is attracted and moved to the magnet member 33. For example, the lower end portion may be comprised of a ferromagnet such as iron.

Next, a second embodiment of the invention will be described. Components similar to those in the first embodiment will be designated by the same reference numerals and repetitive explanations for those will be omitted.

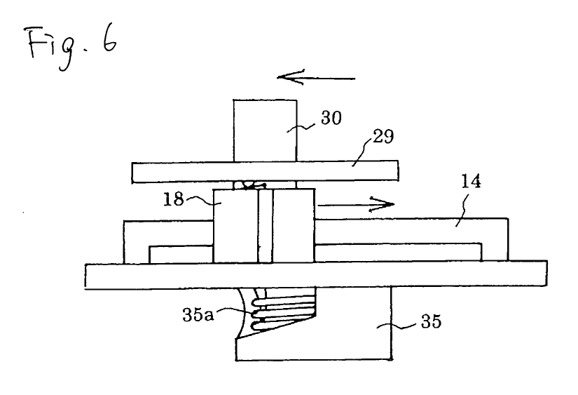

As shown in FIG. 5, an electromagnet 35 is fixed to the lower face of the board 13 at the position corresponding to the neutral position. Electric power is supplied to the electromagnet 35 through a conductive member (not shown) which is in contact with a power source. The electromagnet 35 includes a coil 35a with an iron core, so that the setting of voltage applied to the electromagnet 35 is able to change arbitrarily.

As shown in FIG. 6, when the power source is activated, the electromagnet 35 is driven, and a magnetic force for attracting the permanent magnet 32 (or a ferromagnet) is generated in the electromagnet 35. Accordingly, when the operating force is released after the moving operation of the operating stick 28, i.e., after moving and displacing the shaft 30 in an arbitrary direction from the position above the electromagnet 35, the lower end portion of the shaft 30 is magnetically attracted by the electromagnet 35, and immediately moves to the position above the electromagnet 35. For this reason, the operating stick 28 is returned to the neutral position reliably and speedily.

The magnitude of the magnetic force acting between the permanent magnet 32 and the electromagnet 35 is controlled so as to be variable by changing a value of voltage applied to the electromagnet 35. For this reason, by setting the magnitude of the magnetic force to a required value, it is possible to appropriately change the magnetically attracting force between the electromagnet 35 and the permanent magnet 32. Accordingly, by changing the voltage value of the electromagnet 35 in correspondence with the conditions of use and application of the operating stick 28, it is possible to impart appropriate relative hardness to the operation feeling, thereby making it possible to easily obtain flexible operability of the operating stick 28.

Next, a third embodiment of the invention will be described. Components similar to those in the first embodiment will be designated by the same reference numerals and repetitive explanations for those will be omitted.

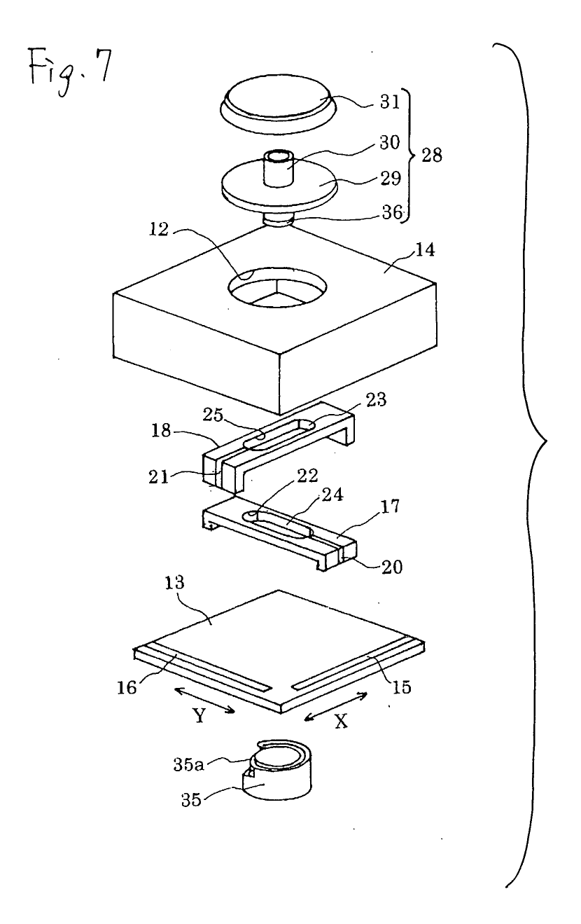

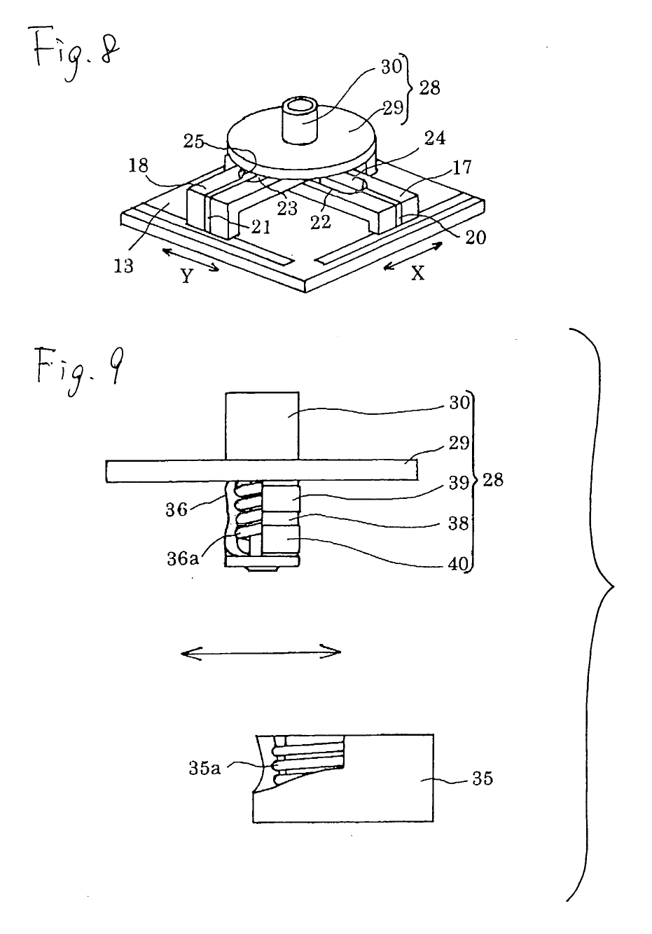

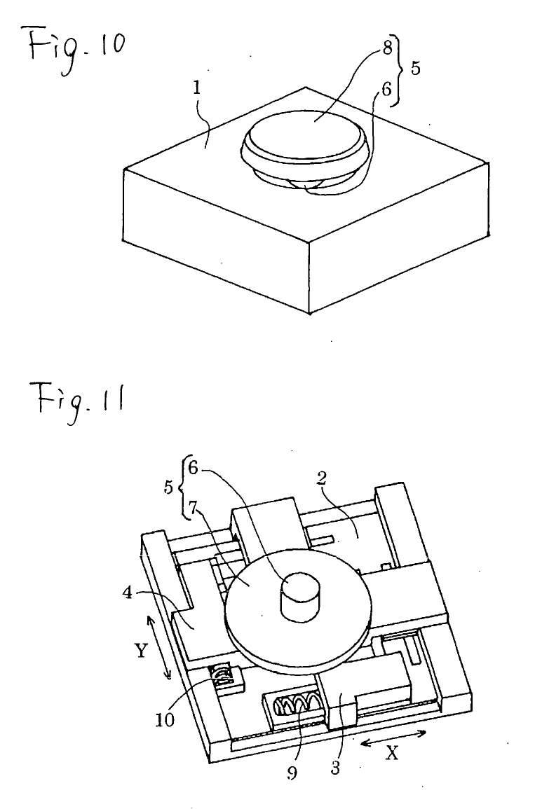

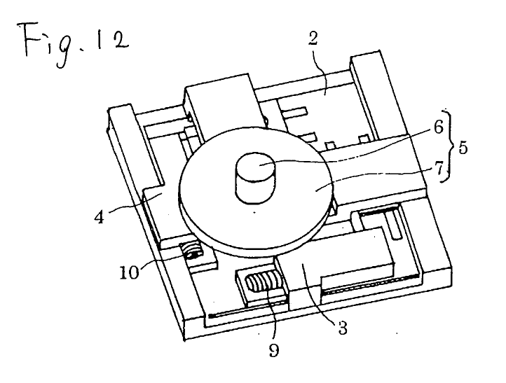

As shown in FIG. 7, the electromagnet 35 is attached to the lower face of the board 13 at the position corresponding to fixed the neutral position, and an electromagnet 36 is provided on the lower end portion of the shaft 30. As shown in FIG. 9, the electromagnets 35 and 36 include coils 35a and 36a with iron cores respectively, so that values of voltage applied to the electromagnets 35 and 36 are arbitrarily variable within desired ranges. Electric power is supplied to the electromagnet 35 through a conductive member (not shown) which is in contact with a power source.

An insulator 38 is provided on an intermediate portion below the flange 29 of the hollow shaft 30, and third contact portions 39 and 40 is respectively formed on upper and lower sides with the insulator 38. The shaft 30 is operated so as to be moved in an arbitrary direction while the third contact portions 39 and 40 are brought into contact with the second contact portions 24 and 25 of the slots 22 and 23 respectively. Further, as shown in FIG. 8, the second contact portions 24 and 25 are connected to the first contact portions 15 and 16 on the board 13 through the conductors 20 and 21 on the obverse faces of the cranks 17 and 18 respectively. When the power source (not shown) connected to these contact portions 15 and 16 is activated, electric power is supplied to the electromagnet 36.

When the power source is activated, in a case where the operating stick 28 is used, the electromagnets 35 and 36 are driven, and an electromagnetic forces are generated in the two electromagnets. Accordingly, when the operating force is released after the moving operation of the operating stick 28, the electromagnet 36 moves to the position above the electromagnet 35 in a non-contact manner, so that the operating stick 28 is immediately returned to the neutral position.

The magnitudes of the magnetic forces in the electromagnets 35 and 36 are variably controlled by changing values of each voltage applied thereto. Therefore, it is possible to arbitrarily adjust and change the electromagnetically attracting force between the electromagnets 35 and 36. As a result, it is possible to impart more delicate relative hardness to the operation feeling depending on the user's preference or application, thereby making it possible to easily obtain more flexible operability of the operating stick 28.

In addition, there is a possibility that foreign objects such as metal dust which entered the interior of the cover case 14 may be attached to the electromagnet 36. In this case, if peripheries of the shaft 30 are formed into a hermetically sealed structure, the attachment of the foreign objects may be prevented. However, even if the hermetic structure is not adopted, it is possible to prevent the attachment of the foreign objects. Namely, since the lower end portion of the shaft 30 is formed with the electromagnet 36, it is possible to reliably prevent the attachment of the foreign objects to the electromagnet 36 by deactivating the electromagnet 36. If the power source of the electromagnet 36 is deactivated particularly when the joy stick is not used for a long period of time, the effect of prevention of the attachment of the foreign objects is noticeable.

The cranks 3 and 4 are not limited to a crank structure insofar as the shaft of the operating stick is passed through the slot of the crank, and the operating stick is operated so as to be moved in an arbitrary direction on the board, so that it is possible to adopt the other structure.

The operating stick 28 is operated so as to be moved from the neutral position of the X-Y coordinates to an arbitrary position, but the invention is not limited to the same insofar as the operating stick 28 is operable so as to be movable or rotatable (pivotable) to an arbitrary position in a uniaxial or triaxial direction.

In the invention, various changes and modifications may be made without departing from the spirit of the invention, and it goes without saying that such changes and modifications are intended to be covered by the invention.

What is claimed is:

1. A joy stick comprising:
a board, having a first face and a second face opposite to the first face;
a movable member, provided on the first face so as to be movable in a first direction;
an operating stick, coupled to the movable member, thereby being movable in the first direction from a neutral position thereof;
a first magnetic member, provided on the operating stick so as to oppose the first face; and
a second magnetic member, fixed on the second face so as to oppose the neutral position,
wherein the first magnetic member and the second magnetic member are configured to be attractive to each other.

2. The joy stick as set forth in claim 1,
wherein the first magnetic member comprises a permanent magnet and the second magnetic member comprises a permanent magnet.

3. The joy stick as set forth in claim 1,
wherein the first magnetic member comprises a permanent magnet and the second magnetic member comprises an electromagnet.

4. The joy stick as set forth in claim 1,
wherein the first magnetic member comprises a permanent magnet and the second magnetic member comprises a magnetic material.

5. The joy stick as set forth in claim 1,
wherein the first magnetic member comprises an electromagnet and the second magnetic member comprises a permanent magnet.

6. The joy stick as set forth in claim 1,
wherein the first magnetic member comprises an electromagnet and the second magnetic member comprises an electromagnet.

7. The joy stick as set forth in claim 1,
wherein the first magnetic member comprises an electromagnet and the second magnetic member comprises a magnetic material.

8. The joy stick as set forth in claim 1,
wherein the first magnetic member comprises a magnetic material and the second magnetic member comprises a permanent magnet.

9. The joy stick as set forth in claim 1,
wherein the first magnetic member comprises a magnetic material and the second magnetic member comprises an electromagnet.
